(19) United States
(12) Patent Application Publication
(10) Pub. No.: US 2009/0193436 A1
(43) Pub. Date: Jul. 30, 2009

(54) Alarm display system of cluster storage system and method thereof

(75) Inventors: Qi-Fei Du, Tianjin (CN); Tom Chen, Taipei (TW); Win-Harn Liu, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 12/010,831

(22) Filed: Jan. 30, 2008

(51) Int. Cl. G06F 13/00

(52) U.S. Cl. 719/318

(57) ABSTRACT

An alarm display system of a cluster storage system and a method thereof are described. A reasonable single abnormal event processing manner is adopted to classify the alarm priority through abnormal events detected by different nodes sharing a common device in the cluster storage system, and analyze load of each node. That is, nodes with lower loads are analyzed to obtain all the abnormal events of the common device and the node most affected by the abnormal events in the cluster storage system. Afterward, the analysis result is transmitted to each node, and each node then informs a subscriber with an alarm prompt, so as to reasonably and correctly alarm the subscriber with abnormal events of the common device and impacts thereof on the nodes.

### BACKGROUND OF THE INVENTION

1. Field of Invention

The present invention relates to an alarm display system and a method thereof applicable to a computer system, and more particularly, to an alarm display system of a cluster storage system and a method thereof for performing alarm processing on abnormal events of a common device in the cluster storage system.

2. Related Art

Presently, in a PC cluster storage system, an alarm system is usually set to monitor some critical software/hardware objects and events related thereto. When an abnormality occurs to a monitored object, the alarm system informs a subscriber with the abnormal situation in a particular manner, for example, through page display, E-mail, and SNMP (short for Simple Network Management Protocol, which is a TCP/IP protocol for defining management problems of each node in the network) prompt. The cluster, as a whole, includes common devices (for example, disks) and independent devices (such as CPU and memories). Each node has the same alarm module, and when a device abnormity is detected, in the conventional art, each node handles the abnormal event individually, and it is the same with the common devices. As such, on detecting that various abnormal events occur to a common device, different nodes may adopt different processing manners, and what is worse, different abnormities of the same device may be displayed on the page. This is undoubtedly an incorrect and improper alarm processing manner, which may puzzle the subscriber on the alarm information.

Particularly, with the increase of the nodes in the cluster, more and more software/hardware objects need to be monitored by the system, and the above conventional alarm processing manner no doubt has great defects.

### SUMMARY OF THE INVENTION

In order to solve the problems and defects in the conventional art, the present invention is directed to an alarm display system of a cluster storage system and a method thereof. A reasonable single abnormal event processing manner is adopted to classify through damage degree of abnormal events occurring to a common device in the cluster storage system, and analyze the abnormal events, so as to reasonably and correctly alarm a subscriber with abnormal events of the common device.

An alarm display system of a cluster storage system is provided, which includes: an alarm information acquisition and storage module, for monitoring abnormal events detected by nodes of the common device through polling and interrupt, storing the obtained alarm information of the abnormal events into an alarm information database, and meanwhile storing the abnormal events into an alarm event database; a node load analysis module, for performing a sort operation on the load information of each node sharing the common device where the abnormal events occur to obtain nodes respectively with the lowest and the highest load, and designating the node with the lowest load to carry out alarm analysis on the abnormal events of the common device; an alarm information analysis processing module, for analyzing the node-detected abnormal events stored in the alarm event database and alarm information corresponding to the abnormal events stored in the alarm information database, and determining an alarm processing priority of the abnormal events according to the analysis result of the alarm information, then providing the information of the abnormal events occurring to the common device and the node most affected by the abnormal events to each node according to the alarm processing priority and the node with the highest load obtained by the node load analysis module, and informing a subscriber with an alarm prompt by each node; and an alarm module, for informing the subscriber with an alarm prompt by selectively calling different alarm modes according to various monitored objects and alarm levels.

An alarm display method of a cluster storage system is provided, which includes the following steps: monitoring abnormal events detected by nodes of the common device through polling and interrupt, and obtaining load information of each node; storing the obtained abnormal events and alarm information of the abnormal events; performing a sort operation on the load information of each node sharing the common device where the abnormal events occur to obtain nodes respectively with the lowest and the highest load, and designating the node with the lowest load to carry out alarm analysis on the abnormal events of the common device; analyzing the stored abnormal events detected by the nodes and alarm information corresponding to the stored abnormal events, and determining an alarm processing priority of the abnormal events according to the analysis result of the alarm information; and providing the information of the abnormal events occurring to the common device and the node most affected by the abnormal events to each node according to the alarm processing priority and the obtained node with the highest load, and informing a subscriber with an alarm prompt by each node.

In view of the above, the present invention has the following advantages.

According to the alarm display system of a cluster storage system and the method thereof provided by the present invention, abnormities of a common device are comprehensively considered from various factors possibly existing in the system that affect the performances of the device, and alarm prompts are made, so as to effectively inform the subscriber to reasonably and correctly handle abnormal events of the common device in the cluster storage system. Further, according to the alarm display system of a cluster storage system and the method thereof provided by the present invention, abnormal events detected by different nodes that share a common device are classified by alarm priority, and node load of each node is analyzed. That is, nodes with lower loads are analyzed to obtain all the abnormal events of the common device and the node most affected by the abnormal events in the cluster storage system. Afterward, the analysis result is provided to each node, and each node then informs a subscriber with an alarm prompt, so as to effectively prevent the problem that different nodes sharing the common device operate individually to result in various abnormal alarms on the common device at the same time. In addition, according to the alarm display system of a cluster storage system and the method thereof provided by the present invention, alarms of abnormal events are handled by nodes with lower loads, so as to further balance the pressure on the device in the cluster storage system.

### BRIEF DESCRIPTION OF THE DRAWINGS

The present invention will become more fully understood from the detailed description given herein below for illustration only, and thus are not limitative of the present invention, and wherein:

FIG. 1 is a system block view of an alarm display system of a cluster storage system according to the present invention; and

FIG. 2 is a flow chart of an alarm display method of a cluster storage system according to the present invention.

### DETAILED DESCRIPTION OF THE INVENTION

The preferred embodiments of the present invention will be illustrated in detail below with the accompanying drawings.

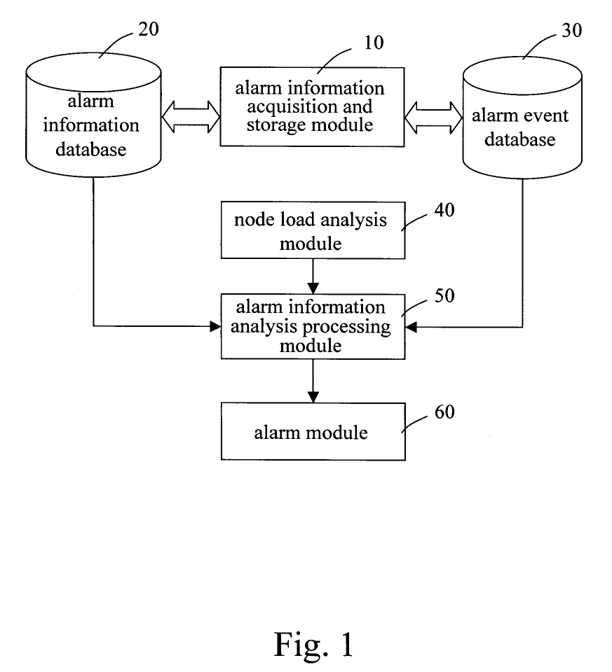

Referring to FIG. 1, a system block view of an alarm display system of a cluster storage system according to the present invention is shown. The alarm display system is used to perform alarm processing on abnormal events of a common device in the cluster storage system. As shown in the figure, the alarm display system of a cluster storage system provided by the present invention includes an alarm information acquisition and storage module 10, a node load analysis module 40, an alarm information analysis processing module 50, and an alarm module 60.

The alarm information acquisition and storage module 10 is used for monitoring abnormal events detected by nodes of the common device through polling and interrupt, storing the obtained alarm information of the abnormal events into an alarm information database 20, and meanwhile storing the abnormal events into an alarm event database 30.

The node load analysis module 40 is used for performing a sort operation on the load information of each node sharing the common device where the abnormal events occur to obtain nodes respectively with the lowest and the highest load, and designating the node with the lowest load to carry out alarm analysis on the abnormal events of the common device. In the cluster storage system, as the using pressure from the subscriber is different, the load of each node varies, and thus the data traffic at each node has great difference. When an abnormity occurs to the common device, the node with the largest load and greatest data traffic (i.e., with the highest load) may be most affected by the abnormal event. Thus, the load information of each node is gathered by taking the above two factors into consideration, and the node most affected by using the common device where the abnormal event occurs is obtained.

The alarm information analysis processing module 50 is used for analyzing the node-detected abnormal events stored in the alarm event database 30 and alarm information corresponding to the abnormal events stored in the alarm information database 20, and determining an alarm processing priority of the abnormal events according to the analysis result of the alarm information, then providing the information of the abnormal events occurring to the common device and the node most affected by the abnormal events to each node according to the alarm processing priority and the node with the highest load obtained by the node load analysis module 40, and informing the subscriber with an alarm prompt by each node.

The alarm module 60 is used for informing the subscriber with an alarm prompt by selectively calling different alarm modes according to various monitored objects and alarm levels, in which different monitored objects refer to various abnormal events and the node most affected by the abnormal events, so as to adopt different alarm operations in accordance with different monitored objects and alarm levels under the designation of the subscriber. Different monitored objects and alarm levels are corresponding to specific alarm modes according to the type and severity degree or significance thereof. For example, an alarm prompt can be informed to the subscriber through page display, LED alarm, buzzing alarm, SNMP Trap prompt, E-mail prompt, and log record. SNMP short for Simple Network Management Protocol is a series of protocol suites and regulations, for providing a method of collecting network management information from devices in the network. Further, the SNMP also provides a method for devices to report problems and errors to a network management workstation. An agent in each managed device reports error situations to the network management workstation at any time, such as the exceeding degree of preset thresholds. It is not necessary for the agent to wait to report till the management workstation performs polling to obtain the error situations. And the error situations are informed to the subscriber through so-called SNMP Trap prompt, E-mail prompt, and log record. The subscriber selects designated alarm modes according to the types or levels of different alarms, and thus the system selects the alarm modes corresponding to different monitored objects and alarm levels. The selection of the alarm modes will be dynamically adjusted during the operation of the system according to historical data of each item, so as to obtain an alarm mode that most satisfies the expectation of the subscriber and is most practical.

The alarm information of the abnormal events includes the information of the level of each abnormal event and the historical occurrence frequency of each abnormal event, in which each abnormal event is classified as at a low, medium, or high level in the following manner.

Abnormal events affecting the normal usage of the common device are set at a low level, for example, the insufficiency of device space and other abnormal events.

Abnormal events resulting in damage or failure of a common software device are set at a medium level. For example, the damage of a device with redundant arrays of inexpensive disks (RAID) may cause errors in the read and write of data and thus affect the completeness of the data, or even result in failure of the device.

Abnormal events resulting in damage or failure of a common hardware device are set at a high level. Such abnormal events must be processed immediately, for example, the damaged device is automatically removed from the system in time, or the subscriber is reminded to manually pull out and replace the damaged device in time, and thus the data of the subscriber may not be affected.

Further, the historical occurrence frequency of each abnormal event refers to times that the abnormal event occurs in a preset time period (for example, in a time period of Δt), and the preset time period is preferably 20 seconds according to the requirements.

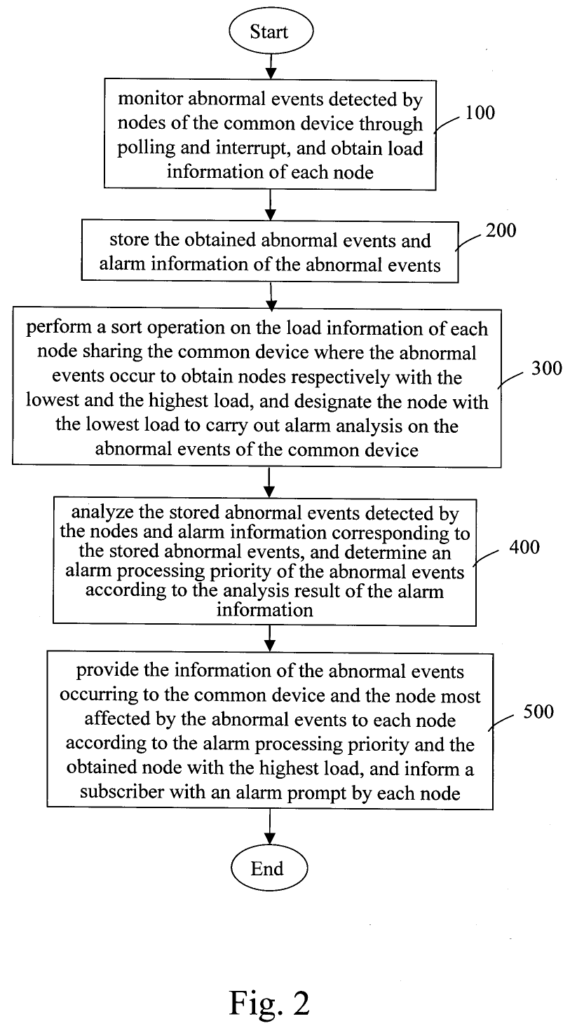

Now referring to FIG. 2, a flow chart of an alarm display method of a cluster storage system according to the present invention is shown. The alarm displaying method is used to perform alarm processing on abnormal events of a common device in the cluster storage system. As shown in the figure, the alarm display method of a cluster storage system provided by the present invention includes the following steps.

First, abnormal events detected by nodes of the common device are monitored through polling and interrupt, and load information of each node is obtained (Step 100).

Next, store the obtained abnormal events and alarm information of the abnormal events (Step 200).

Then, a sort operation is performed on the load information of each node sharing the common device where the abnormal events occur to obtain nodes respectively with the lowest and the highest load, and the node with the lowest load is designated to carry out alarm analysis on the abnormal events of the common device (Step 300). In the cluster storage system, as the using pressure from the subscriber is different, the load of each node varies, and thus the data traffic at each node has great difference. When an abnormity occurs to the common device, the node with the largest load and greatest data traffic (i.e., with the highest load) may be most affected by the abnormal event. Thus, the load information of each node is gathered by taking the above two factors into consideration, and the node most affected by using the common device where the abnormal event occurs is obtained.

Afterward, the stored abnormal events detected by the nodes and alarm information corresponding to the stored abnormal events are analyzed, and an alarm processing priority of the abnormal events is determined according to the analysis result of the alarm information (Step 400).

Finally, the abnormal events occurring to the common device and the information of the node most affected by the abnormal events are provided to each node according to the alarm processing priority and the obtained node with the highest load, and each node informs the subscriber with an alarm prompt (Step 500).

Besides, the alarm display method of a cluster storage system provided by the present invention further includes a step of informing the subscriber with an alarm prompt by selectively calling different alarm modes according to various monitored objects and alarm levels (not shown), in which different monitored objects refer to various abnormal events and the node most affected by the abnormal events, so as to adopt different alarm operations in accordance with different monitored objects and alarm levels under the designation of the subscriber. Different monitored objects and alarm levels are corresponding to specific alarm modes according to the type and severity degree or significance thereof. For example, an alarm prompt can be informed to the subscriber through page display, LED alarm, buzzing alarm, SNMP Trap prompt, E-mail prompt, and log record. SNMP short for Simple Network Management Protocol is a series of protocol suites and regulations, for providing a method of collecting network management information from devices in the network. Further, the SNMP also provides a method for devices to report problems and errors to a network management workstation. An agent in each managed device reports error situations to the network management workstation at any time, such as the exceeding degree of preset thresholds. It is not necessary for the agent to wait to report till the management workstation performs polling to obtain the error situations. And the error situations are informed to the subscriber through so-called SNMP Trap prompt, E-mail prompt, and log record. The subscriber selects designated alarm modes according to the types or levels of different alarms, and thus the system selects the alarm modes corresponding to different monitored objects and alarm levels. The selection of the alarm modes will be dynamically adjusted during the operation of the system according to historical data of each item, so as to obtain an alarm mode that most satisfies the expectation of the subscriber and is most practical.

In addition, the alarm information of the abnormal events includes the information of the level of each abnormal event and the historical occurrence frequency of each abnormal event, in which each abnormal event is classified as at a low, medium, or high level in the following manner.

Abnormal events affecting the normal usage of the common device are set at a low level, for example, the insufficiency of device space and other abnormal events.

Abnormal events resulting in damage or failure of a common software device are set at a medium level. For example, the damage of a device with redundant arrays of inexpensive disks (RAID) may cause errors in the read and write of data and thus affect the completeness of the data, or even result in failure of the device.

Abnormal events resulting in damage or failure of a common hardware device are set at a high level. Such abnormal events must be processed immediately, for example, the damaged device is automatically removed from the system in time, or the subscriber is reminded to manually pull out and replace the damaged device in time, and thus the data of the subscriber may not be affected.

Further, the historical occurrence frequency of each abnormal event refers to times that the abnormal event occurs in a preset time period (for example, in a time period of Δt), and the preset time period is preferably 20 seconds according to the requirements.

Some detailed technical features of the present invention are described below with reference to Tables 1 and 2.

When a node in the cluster detects that an abnormity occurs to the common device, the same node may send alarm information and the information of the load thereof simultaneously to nodes sharing the common device (for example, the nodes Node1 and Node2 sharing the common device Device1 as shown in Table 2). The sent alarm information, as shown in Table 1, includes the information of the level of each abnormal event (Error1, Error 2, . . . ) and the historical occurrence frequency of each abnormal event. The node with the lowest load is determined through analysis to process the alarm events. In particular, the node with the lowest load processes each abnormal event according to the level and historical occurrence frequency of the same. Especially, when different abnormal events are detected at the same time, the node with the lowest load determines the processing priority of the abnormal events according to the alarm information. Meanwhile, referring to Table 2, the node with the lowest load determines the most affected node according to different abnormal events (when an abnormity occurs to the common device, the node with the largest load and greatest data traffic is usually most seriously affected), so as to inform the subscriber with the reasonable abnormal information of the node most affected by the abnormal events. Thereby, the subscriber may adjust and process correspondingly according to practical situations of the system, for example, appropriately adjusting the load situation of the most affected node.

TABLE 1

| Abnormal | | Historical Occurrence |
|---|---|---|
| Event | Abnormal Level | Frequency |
| Error1, | Classifying the abnormal | Recording times that the |
| Error2 . . . | event as at a low, medium, or | abnormal event occurs in a |
| | high level according to its | past time period of Δt |
| | impact degree on the system | |
| . . . | . . . | . . . |

TABLE 2

| Common | | |
|---|---|---|
| Device | Node sharing the Device | Node Load |
| Device1 | Node1, Node2 . . . | Determined according to the |
| | | data traffic and load of the |
| | | node |
| . . . | . . . | . . . |

The specific implementation of the technique provided by the present invention is given below in two embodiments.

### EMBODIMENT ONE

At time t1, when a node Node1 in the cluster detects that low level abnormal events E1 and E2 occur to a common device Device1, the node Node1 immediately sends the information of the detected abnormal events and the node load itself to nodes sharing the device Device1. Meanwhile, other nodes detect the same abnormal events E1 and E2, and send the information of the abnormal events and the node loads themselves to nodes sharing the device Device1. As the node with the lowest load NodeL analyzes the abnormal information, considering the load of the node Node5 is the highest and the historical occurrence frequency of the abnormal event E2 is higher than that of the abnormal event E1, the node NodeL preferentially performs alarm processing on the abnormal event E2, and then on the abnormal event E1. It is shown on the page at the same time that: the node Node5 is most affected by the abnormal events, to remind the subscriber.

### EMBODIMENT TWO

At time t2, when a node Node1 in the cluster detects that a low level abnormal event E1 and a high level abnormal event E2 occur to a common device Device1, the node Node1 immediately sends the information of the detected abnormal events and the node load itself to nodes sharing the device Device1. Meanwhile, other nodes detect the same abnormal events E1 and E2, and send the information of the abnormal events and the node loads themselves to nodes sharing the device Device1. As the node with the lowest load NodeL analyzes the abnormal information, considering the load of the node Node5 is the highest, the node NodeL preferentially performs alarm processing on the abnormal event E2, and then on the abnormal event E1. It is shown on the page at the same time that: the node Node5 is most affected by the abnormal events, to remind the subscriber.

What is claimed is:

1. An alarm display system of a cluster storage system, for performing alarm processing on abnormal events of a common device in the cluster storage system, comprising:
an alarm information acquisition and storage module, for monitoring abnormal events detected by nodes of the common device through polling and interrupt, storing the obtained alarm information of the abnormal events into an alarm information database, and meanwhile storing the abnormal events into an alarm event database;
a node load analysis module, for performing a sort operation on the load information of each node sharing the common device where the abnormal events occur to obtain nodes respectively with the lowest and the highest load, and designating the node with the lowest load to carry out alarm analysis on the abnormal events of the common device;
an alarm information analysis processing module, for analyzing the node-detected abnormal events stored in the alarm event database and alarm information corresponding to the abnormal events stored in the alarm information database, and determining an alarm processing priority of the abnormal events according to the analysis result of the alarm information, then providing the information of the abnormal events occurring to the common device and the node most affected by the abnormal events to each node according to the alarm processing priority and the node with the highest load obtained by the node load analysis module, and informing a subscriber with an alarm prompt by each node; and
an alarm module, for informing the subscriber with an alarm prompt by selectively calling different alarm modes according to various monitored objects and alarm levels.

2. The alarm display system of a cluster storage system as claimed in claim 1, wherein the alarm information of the abnormal events comprises the information of the level of each abnormal event and the historical occurrence frequency of each abnormal event.

3. The alarm display system of a cluster storage system as claimed in claim 2, wherein each abnormal event is classified as at a low, medium, or high level in the following manner:
setting abnormal events affecting the normal usage of the common device at a low level;
setting abnormal events resulting in damage or failure of a common software device at a medium level; and
setting abnormal events resulting in damage or failure of a common hardware device at a high level.

4. The alarm display system of a cluster storage system as claimed in claim 2, wherein the historical occurrence frequency of each abnormal event refers to times that the abnormal event occurs in a preset time period.

5. The alarm display system of a cluster storage system as claimed in claim 1, wherein the alarm mode comprises page display, LED alarm, buzzing alarm, Simple Network Management Protocol (SNMP) Trap prompt, E-mail prompt, and log record.

6. An alarm display method of a cluster storage system, for performing alarm processing on abnormal events of a common device in the cluster storage system, comprising:
monitoring abnormal events detected by nodes of the common device through polling and interrupt, and obtaining load information of each node;
storing the obtained abnormal events and alarm information of the abnormal events;
performing a sort operation on the load information of each node sharing the common device where the abnormal events occur to obtain nodes respectively with the lowest and the highest load, and designating the node with the lowest load to carry out alarm analysis on the abnormal events of the common device;
analyzing the stored abnormal events detected by the nodes and alarm information corresponding to the stored abnormal events, and determining an alarm processing priority of the abnormal events according to the analysis result of the alarm information; and
providing the information of the abnormal events occurring to the common device and the node most affected by the abnormal events to each node according to the alarm processing priority and the obtained node with the highest load, and informing a subscriber with an alarm prompt by each node.

7. The alarm display method of a cluster storage system as claimed in claim 6, wherein the alarm information of the abnormal events comprises the information of the level of each abnormal event and the historical occurrence frequency of each abnormal event.

8. The alarm display method of a cluster storage system as claimed in claim 7, wherein each abnormal event is classified as at a low, medium, or high level in the following manner:
setting abnormal events affecting the normal usage of the common device at a low level;
setting abnormal events resulting in damage or failure of a common software device at a medium level; and
setting abnormal events resulting in damage or failure of a common hardware device at a high level.

9. The alarm display method of a cluster storage system as claimed in claim 7, wherein the historical occurrence frequency of each abnormal event refers to times that the abnormal event occurs in a preset time period.

10. The alarm display method of a cluster storage system as claimed in claim 6, further comprising informing the subscriber with an alarm prompt by selectively calling different alarm modes according to various monitored objects and alarm levels, wherein the alarm modes comprise page display, LED alarm, buzzing alarm, SNMP Trap prompt, E-mail prompt, and log record.
